(19) United States
(12) Patent Application Publication
(10) Pub. No.: US 2026/0161880 A1
(43) Pub. Date: Jun. 11, 2026

(54) METHOD AND SYSTEM FOR APPLICATION PAGE CREATION

(71) Applicant: HCL Technologies Limited, New Delhi (IN)

(72) Inventor: Bhuwan Bhasker, Windsor (GB)

(21) Appl. No.: 19/094,814

(22) Filed: Mar. 29, 2025

(30) Foreign Application Priority Data
Dec. 11, 2024 (IN) 202411097945

(51) Int. Cl. G06F 40/14; G06F 3/0482; G06F 3/04845; G06F 40/186

(52) U.S. Cl. CPC G06F 40/14; G06F 3/0482; G06F 3/04845; G06F 40/186

(57) ABSTRACT

A method for application page creation is disclosed. The method includes receiving, via a GUI, a template selection from a plurality of templates for an application page from a user device. For each row-level web component of the plurality of row-level web components in the template selection, the method further includes preparing a deployment package for the row-level web component. The method further includes evaluating the deployment package through one or more automated gates. Upon successful evaluation, the method further includes deploying the row-level web components through the deployment package on the application page. The method further includes rendering, via the GUI, the application page with the deployed row-level web component based on the template selection on the end user device.

### TECHNICAL FIELD

This disclosure relates generally to application development, and more particularly to method and system for application page creation.

### BACKGROUND

In the present state of art, conventional application development tools (such as web development platforms) allow users to create application page layouts which can be split vertically and horizontally into multiple rows and columns. Additionally, a row can be further split into multiple columns and a column can be further split into multiple rows. While the splitable row and column feature is intended to provide flexibility and customizability to the users, such layouts may produce unappealing application pages especially when the user is an amateur developer or a non-developer. Thus, certain level of application design and application development knowledge is required for the user to be able to operate the conventional application development tools.

Additionally, the conventional application development tools may create performance bottlenecks as recursive splitting of the application page may create a large number of JavaScript objects on the application page. Higher number of JavaScript objects may cause a higher Central Processing Unit (CPU) consumption for processing and a higher memory usage for storage.

Further, the conventional application development tools may add reusable components to the application page that are often either sub optimal or require effort and time to develop and productionize. This may lead to an enormous lag in value delivery, high cost, and high inertia to pivots and transformations. Additionally, the developers of these reusable components are required to be adept at analytics, Search Engine Optimization (SEO), accessibility, etc., further delaying the process. These reusable components, once developed, are required to be reviewed by experts in analytics, accessibility, and SEO, etc., further increasing time and cost of the feature addition (i.e., addition of the reusable components to the application page).

The present invention is directed to overcome one or more limitations stated above or any other limitations associated with the known arts.

### SUMMARY

In one embodiment, a method for application page creation is disclosed. In one example, the method may include receiving, via a Graphical User Interface (GUI), a template selection for an application page from a user device. Each of the plurality of templates may include a plurality of row-level web components. Each of the plurality of row-level web components may be configured to span across an entire width of a screen of an end user device. Each of the plurality of row-level web components may be restricted from splitting. For each row-level web component of the plurality of row-level web components in the template selection, the method may further include preparing a deployment package for the row-level web component. The deployment package may include the row-level web component and a predefined schema corresponding to each of accessibility, Search Engine Optimization (SEO), and analytics. For each row-level web component of the plurality of row-level web components in the template selection, the method may further include evaluating the deployment package through one or more automated gates. For each row-level web component of the plurality of row-level web components in the template selection, upon successful evaluation, the method may further include deploying the row-level web component through the deployment package on the application page. For each row-level web component of the plurality of row-level web components in the template selection, the method may further include rendering, via the GUI, the application page with the deployed row-level web component based on the template selection, on the end user device.

In another embodiment, a system for application page creation is disclosed. In one example, the system may include a processor, and a computer-readable medium communicatively coupled to the processor. The computer-readable medium may store processor-executable instructions, which on execution, may cause the processor to receive, via a GUI, a template selection from a plurality of templates for an application page from a user device. Each of the plurality of templates may include a plurality of row-level web components. Each of the plurality of row-level web components may be configured to span across an entire width of a screen of an end user device. Each of the plurality of row-level web components may be restricted from splitting. For each row-level web component of the plurality of row-level web components in the template selection, the processor-executable instructions, on execution, may further cause the processor to prepare a deployment package for the row-level web component. The deployment package may include the row-level web component and a predefined schema corresponding to each of accessibility, Search Engine Optimization (SEO), and analytics. For each row-level web component of the plurality of row-level web components in the template selection, the processor-executable instructions, on execution, may further cause the processor to evaluate the deployment package through one or more automated gates. For each row-level web component of the plurality of row-level web components in the template selection, upon successful evaluation, the processor-executable instructions, on execution, may further cause the processor to deploy the row-level web component through the deployment package on the application page. For each row-level web component of the plurality of row-level web components in the template selection, the processor-executable instructions, on execution, may further cause the processor to render, via the GUI, the application page with the deployed row-level web component based on the template selection, on the end user device.

In yet another embodiment, a non-transitory computer-readable medium storing computer-executable instructions for application page creation is disclosed. In one example, the stored instructions, when executed by a processor, may cause the processor to perform operations including receiving a template selection from a plurality of templates for an application page from a user device. Each of the plurality of templates may include a plurality of row-level web components. Each of the plurality of row-level web components may be configured to span across an entire width of a screen of an end user device. Each of the plurality of row-level web components may be restricted from splitting. For each row-level web component of the plurality of row-level web components in the template selection, the operations may further include preparing a deployment package for the row-level web component. The deployment package may include the row-level web component and a predefined schema corresponding to each of accessibility, Search Engine Optimization (SEO), and analytics. For each row-level web component of the plurality of row-level web components in the template selection, the operations may further include evaluating the deployment package through one or more automated gates. For each row-level web component of the plurality of row-level web components in the template selection, upon successful evaluation, the operations may further include deploying the row-level web component through the deployment package on the application page. For each row-level web component of the plurality of row-level web components in the template selection, the operations may further include rendering, via the GUI, the application page with the deployed row-level web component based on the template selection, on the end user device.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for application page creation, in accordance with some embodiments of the present disclosure.

FIG. 2 illustrates a functional block diagram of various modules within a memory of a computing device configured for application page creation, in accordance with some embodiments of the present disclosure.

FIG. 3 illustrates a flow diagram of an exemplary process for application page creation, in accordance with some embodiments of the present disclosure.

FIG. 4 illustrates a flow diagram of an exemplary process for preparing deployment packages for row-level web components, in accordance with some embodiments of the present disclosure.

FIG. 5 illustrates a block diagram of an exemplary deployment package, in accordance with some embodiments of the present disclosure.

FIG. 6 illustrates an exemplary process for evaluating deployment packages, in accordance with some embodiments of the present disclosure.

FIG. 7 illustrates an exemplary Graphical User Interface (GUI) presenting an application page with the deployed row-level web component, in accordance with some embodiments of the present disclosure.

FIG. 8 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

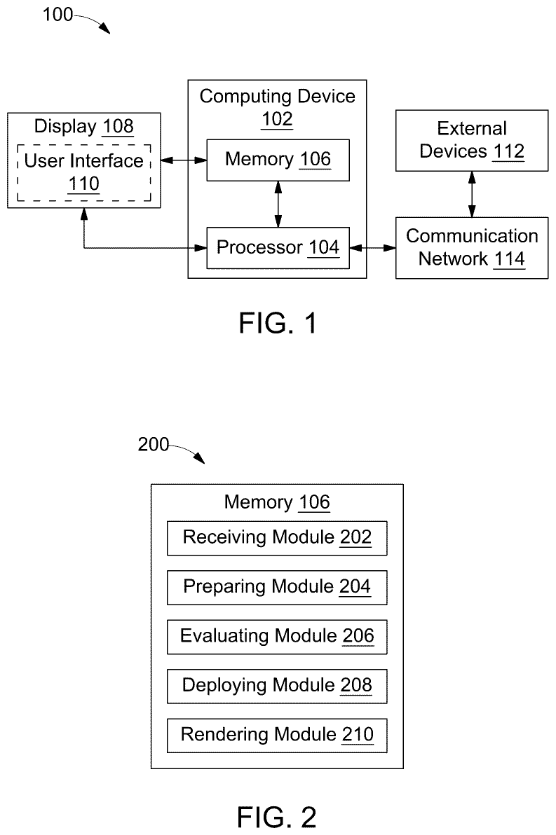

Referring now to FIG. 1, an exemplary system for application page creation is illustrated, in accordance with some embodiments of the present disclosure. The system 100 may include a computing device 102. The computing device 102 may be, for example, but may not be limited to, server, desktop, laptop, notebook, netbook, tablet, smartphone, mobile phone, or any other computing device, in accordance with some embodiments of the present disclosure. The computing device 102 may be accessed by a user to create an application page. The user may be a developer or any general user that may or may not possess prior coding knowledge. The application page created may be rendered on an end user device (not shown in figure). The application page may include row-level web components that span across an entire width of a screen of the end user device. The end user device may be operated by an end user. The end user may or may not be same as the user who created the application page.

As will be described in greater detail in conjunction with FIGS. 2-8, the computing device 102 may receive, via a GUI, a template selection from a plurality of templates for an application page from a user device. It should be noted that each of the plurality of templates may include a plurality of row-level web components. It should also be noted that each of the plurality of row-level web components may be configured to span across an entire width of a screen of the user device. It should also be noted that each of the plurality of row-level web components may be restricted from splitting. For each row-level web component of the plurality of row-level web components in the template selection, the computing device 102 may further prepare a deployment package for the row-level web component. It should be noted that the deployment package may include the row-level web component and predefined schema corresponding to each of accessibility, Search Engine Optimization (SEO), and analytics. For each row-level web component of the plurality of row-level web components in the template selection, the computing device 102 may further evaluate the deployment package through one or more automated gates. For each row-level web component of the plurality of row-level web components in the template selection, upon successful evaluation, the computing device 102 may further deploy the row-level web component through the deployment package on the application page. For each row-level web component of the plurality of row-level web components in the template selection, the computing device 102 may further render, via the GUI, the application page with the deployed row-level web component based on the template selection on the user device.

In some embodiments, the computing device 102 may include one or more processors 104 and a memory 106. Further, the memory 106 may store instructions that, when executed by the one or more processors 104, cause the one or more processors 104 to create an application page, in accordance with aspects of the present disclosure. The memory 106 may also store various data (for example, a plurality of templates, row-level web components, predefined schema of deployment packages, automated gates, and the like) that may be captured, processed, and/or required by the system 100. The memory 106 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

The system 100 may further include a display 108. The system 100 may interact with a user via a user interface 110 accessible via the display 108. The system 100 may also include one or more external devices 112. In some embodiments, the computing device 102 may interact with the one or more external devices 112 over a communication network 114 for sending or receiving various data. The communication network 114 may include, for example, but may not be limited to, a wireless fidelity (Wi-Fi) network, a light fidelity (Li-Fi) network, a local area network (LAN), a wide area network (WAN), a metropolitan area network (MAN), a satellite network, the internet, a fiber optic network, a coaxial cable network, an infrared (IR) network, a radio frequency (RF) network, and a combination thereof. The one or more external devices 112 may include, but may not be limited to, a remote server, a laptop, a netbook, a smartphone, a mobile phone, a tablet, or any other computing device.

Referring now to FIG. 2, a functional block diagram of various modules within a memory (such as the memory 106) of a computing device (such as the computing device 102) configured for application page creation is illustrated, in accordance with some embodiments of the present disclosure. FIG. 2 is explained in conjunction with FIG. 1. The system 200 may be analogous to the system 100. The system 200 may implement the computing device 102. The memory 106 of the computing device 102 may include a receiving module 202, a preparing module 204, an evaluating module 206, a deploying module 208, and a rendering module 210.

The receiving module 202, may receive, via a GUI, a template selection from a plurality of templates for an application page of an application from a user device. The application page may be a web page or any other application page. By way of an example the application page may correspond to a login page, a user profile page, web page, or a dashboard page of the application. By way of an example, a user may select one template from the plurality of templates for the application page as per their requirement. The template may be a pre-designed layout. The plurality of templates corresponding to the application page may be pre-stored in a database. The user device may be, for example, but may not be limited to, a laptop, a tablet, a mobile phone, a netbook, a notebook, or any other computing device.

It should be noted that each of the plurality of templates may include a plurality of row-level web components. The row-level web components may be, for example, but may not be limited to, design, content, navigation structure, a logo, videos, and graphics. Each of the plurality of row-level web components may be configured to span across an entire width of a screen of the user device. In other words, each of the row-level web components may occupy 100% width of the screen (or display) of the user device. It should also be noted that each of the plurality of row-level web components is restricted from splitting. By way of an example, the plurality of row-level web components may be restricted from splitting a row into multiple columns (or further columns). The plurality of templates may include, for example, but may not be limited to, a two-row template, a three-row template, and a four-row template.

Each of the plurality of row-level web components is vertically movable through a user command. In other words, each of the plurality of row-level web components may only be moved vertically upward and downward over each other, via the user. For each row-level web component of the plurality of row-level web components, the row-level web component may include one or more functional GUI elements. Each of the one or more functional GUI is arranged at a fixed position in the row-level web component. The row-level web component may include one or more slots corresponding to the one or more functional GUI elements.

In an embodiment, the preparing module 204 may generate a new row-level web component through an Artificial Intelligence (AI) model based on the plurality of row-level web components. By way of an example, in case the user may not find any sufficient row-level web component from the database, the user may ask the AI assistant to generate the new row-level web component from the existing row-level web components.

Further, for each row-level web component of the plurality of row-level web components in the template selection, the preparing module 204 may prepare a deployment package for each row-level web component. It should be noted that the deployment package may include the row-level web component and a predefined schema corresponding to each of accessibility, Search Engine Optimization (SEO), and analytics. The predefined schema may include structured data that may enable identification of data to be used for accessibility, SEO, and analytics. To prepare the deployment package, the preparing module 204 may retrieve a predefined code for each of the accessibility, the SEO, and the analytics from the database, based on the corresponding predefined schema. Upon retrieving the predefined code, the preparing module 204 may automatically add the predefined code to the deployment package of the row-level web component. The row-level web component may include one or more functional GUI elements (e.g., a text, an image, an interactive graphic, button, etc.).

Further, for analytics, the preparing module 204 may collect analytics data corresponding to each of the one or more functional GUI elements of the row-level web component from the application page through the predefined code. Further, on collecting the analytics data, the preparing module 204 may provide the analytics data to an analytics tool through the predefined code for analytics. The analytics tool may be, for example, a Microsoft Power BI, a tableau, a Qlik Sense, and the like.

Further, for accessibility, the preparing module 204 may collect accessibility data from each of the one or more functional GUI elements of the row-level web component through the predefined code. Further, on collecting the accessibility data, the preparing module 204 may create accessibility-related tags based on the accessibility data through the predefined code.

Further, for SEO, the preparing module 204 may collect SEO data from each of the one or more functional GUI elements of the row-level web component through the predefined code. Further, on collecting the SEO data, the preparing module 204 may create micro tags and meta tags for the row-level web component based on the SEO data through the predefined code.

Once the deployment package is prepared, the evaluating module 206 may evaluate the deployment package through one or more automated gates. The automated gates may be, for example, but may not be limited to, code quality gates, automated testing gates, security gates, and performance testing gates. Further, upon successful evaluation, the deploying module 208 may deploy the row-level web component through the deployment package on the application page.

Further, the rendering module 210, via the GUI, may render the application page with the deployed row-level web component based on the template selection on the user device.

It should be noted that all such aforementioned modules 202-210 may be represented as a single module or a combination of different modules. Further, as will be appreciated by those skilled in the art, each of the modules 202-210 may reside, in whole or in parts, on one device or multiple devices in communication with each other. In some embodiments, each of the modules 202-210 may be implemented as dedicated hardware circuit comprising custom application-specific integrated circuit (ASIC) or gate arrays, off-the-shelf semiconductors such as logic chips, transistors, or other discrete components. Each of the modules 202-210 may also be implemented in a programmable hardware device such as a field programmable gate array (FPGA), programmable array logic, programmable logic device, and so forth. Alternatively, each of the modules 202-210 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for generating and rendering a customized dashboard. For example, the exemplary system 100 and the associated computing device 102, 200 may generate and render a customized dashboard by the processes discussed herein. As will be appreciated by those of ordinary skill in the art, control logic and/or automated routines for performing the techniques and steps described herein may be implemented by the system 100 and the associated computing device 102, 200 either by hardware, software, or combinations of hardware and software. For example, suitable code may be accessed and executed by the one or more processors 104 on the system 100 to perform some or all the techniques described herein. Similarly, application specific integrated circuits (ASICs) configured to perform some, or all of the processes described herein may be included in the one or more processors 104 on the system 100.

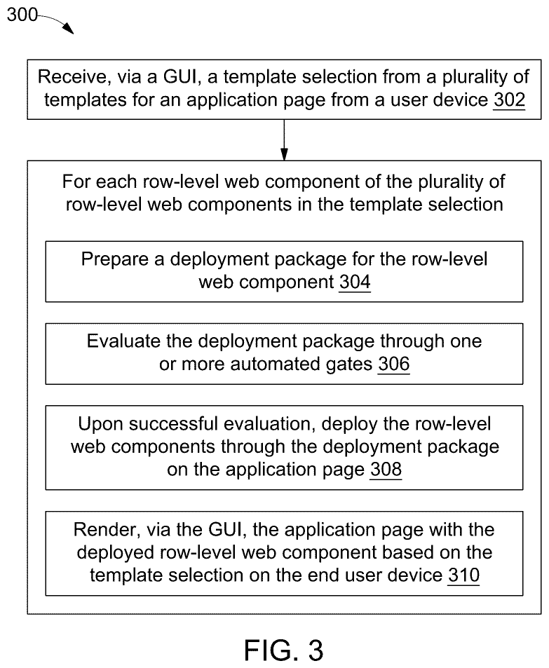

Referring now to FIG. 3, an exemplary process 300 for application page creation is illustrated via a flow chart, in accordance with some embodiments of the present disclosure. The process 300 may be implemented by the computing device 102 of the system 100. In some embodiments, the process 300 may include receiving via a GUI, by the receiving moule 202, a template selection from a plurality of templates for an application page from a user device, at step 302. It should be noted that each of the plurality of templates may include a plurality of row-level web components. Each of the plurality of row-level web components may be configured to span across an entire width of a screen of the user device. It should also be noted that each of the plurality of row-level web components is restricted from splitting.

Each of the plurality of row-level web components is vertically movable through a user command. By way of an example, a user may only be allowed to move the plurality of row-level web components vertically upward or downward on the user device as per their requirement. Further, for each row-level web component of the plurality of row-level web components, the row-level web component may include one or more functional GUI elements. Each of the one or more functional GUI elements is arranged at a fixed position in the row-level web components. The row-level web component may include one or more slots corresponding to the one or more functionals GUI elements.

In some embodiments, the process may include generating, by the preparing module 204, a new row-level web component through an AI model based on the plurality of row-level web components.

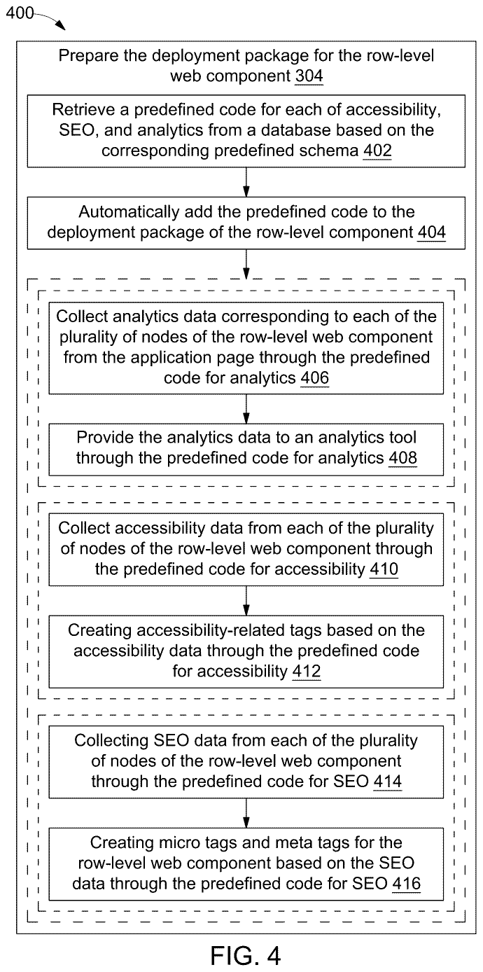

For each row-level web component of the plurality of row-level web components, once the template selection is received, the process 300 may include preparing, by the preparing module 204, a deployment package for each of the row-level web component, at step 304. It should be noted that the deployment package may include the row-level web component and a predefined schema corresponding to each of accessibility, SEO, and analytics. The predefined code may be used to process the data for the SEO and the analytics. In an embodiment, each of the row-level web components may be priorly configured with the predefined schema in the deployment package to optimize the application page. This is further explained in detail in conjunction with FIG. 4.

For each row-level web component of the plurality of row-level web components, upon preparing the deployment package, the process 300 may include evaluating, by the evaluating module 206, the deployment package through one or more automated gates, at step 306. In other words, the deployment package may go through multiple automated gates for the evaluation. The one or more automated gates may perform checks on the deployment package to further optimize the process of the application page creation.

For each row-level web component of the plurality of row-level web components, upon successful evaluation, the process 300 may include deploying, by the deploying module 208, the row-level web component through the deployment package on the application page, at step 308. For each row-level web component of the plurality of row-level web components, once the row-level web component is deployed on the application page, the process 300 may include rendering via the GUI, by the rendering module 210, the application page with the deployed row-level web component based on the template selection on the user device, at step 310.

Referring now to FIG. 4, an exemplary process 400 for preparing a deployment package for each row-level web component is illustrated via a flowchart, in accordance with some embodiments of the present disclosure. FIG. 4 is explained in conjunction with FIG. 3. The process 400 may include preparing, by the preparing module 204, the deployment package for the row-level web component, at step 304. The step 304 of the process 400 may include retrieving, by the preparing module 204, a predefined code for each of accessibility, SEO, and analytics from a database based on the corresponding predefined schema, at step 402. The predefined code associated with accessibility, SEO, and analytics may be pre-stored in the database.

Once the predefined code is retrieved, the process 400 may include automatically adding the predefined code to the deployment package of the row-level web component, at step 404. It should be noted that the row-level web component may include one or more functional GUI elements. The retrieved predefined code gets added to the deployment package to maintain the structure of the application page and to provide added functionality to the row-level web component.

Further, for analytics, the process 400 may include collecting, by the preparing module 204, analytics data corresponding to each of the one or more functional GUI elements of the row-level web component from the application page through the corresponding predefined code, at step 406. Once the analytics data is collected, the process 400 may include providing, by the preparing module 204, the analytics data to an analytics tool (e.g., a dashboard) through the predefined code for analytics, at step 408.

Further, for accessibility, the process 400 may include collecting, by the preparing module 204, accessibility data from each of the one or more functional GUI elements of the row-level web component through the corresponding predefined code, at step 410. Once the accessibility data is collected, the process 400 may include creating, by the preparing module 204, accessibility-related tags based on the accessibility data through the predefined code for accessibility, at step 412.

Further, for SEO, the process 400 may include collecting, by the preparing module 204, SEO data from each of the one or more functional GUI elements of the row-level web component through the predefined code, at step 414. Once the SEO data is collected, the process 400 may include creating, by the preparing module 204, micro tags and meta tags for the row-level web component based on the SEO data through the predefined code for SEO, at step 416. Upon addition of the predefined code for each of analytics, accessibility, and SEO to the row-level web component, the deployment package may be prepared for further processing as already explained in above FIG. 3.

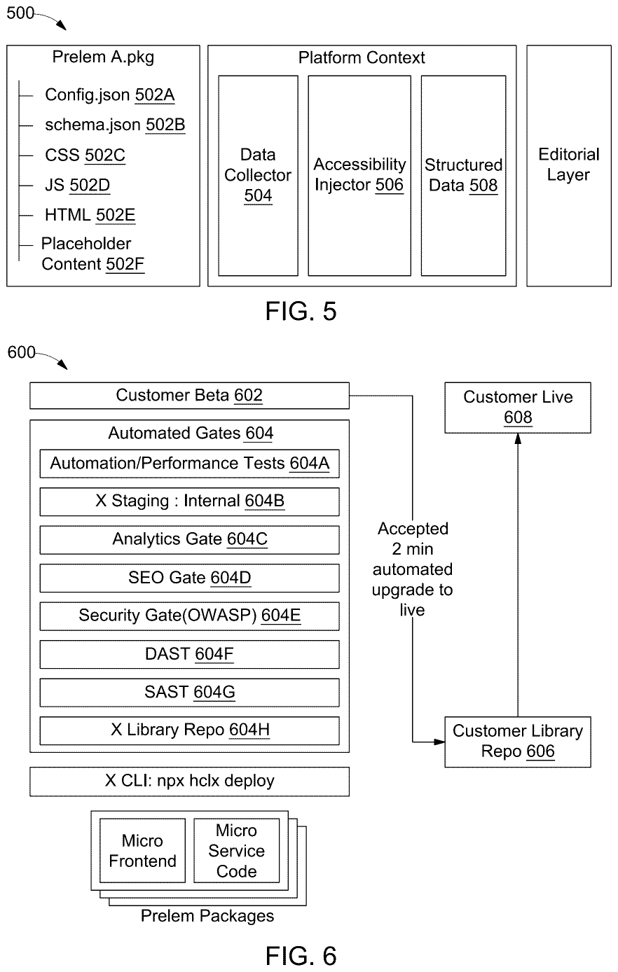

Referring now to FIG. 5, a block diagram of an exemplary deployment package 500 is illustrated, in accordance with some embodiments of the present disclosure. FIG. 5 is explained in conjunction with FIGS. 1-4 . The deployment package 500 may correspond to a row-level web component. The deployment package 500 (such as ‘Prelem A.pkg’) may include various component files corresponding to a row-level web component. The components files may be, for example, but may not be limited to a configuration file (such as ‘Config.json’ 502A), a schema file (such as ‘schema.json’ 502B), a Cascaded Style Sheets (CSS) file (such as ‘CSS’ 502C), a JavaScript (JS) file (such as ‘JS’ 502D), a Hypertext Markup Language (HTML) file (such as ‘HTML’ 502E), and a placeholder content file (such as ‘Placeholder Content’ 502F).

The configuration file may include information associated with configuration settings required for a deployment. The configuration file may further include security parameters for system initialization. The configuration file may further include parameters for environment-specific configurations or any other deployment related specifications.

The schema file may include definition of codes for various blocks used within the deployment package. The schema file may include the predefined schema for each of the accessibility, the SEO, and the analytics. The schema file may define a structure of data corresponding to various code files (i.e., the CSS file, the JS file, and the HTML file) in the deployment package 500. The schema file may ensure data integrity.

The various code files for the row-level web component may include code data corresponding to the one or more functional GUI elements of the row-level web component. The CSS File may include CSS codes for styling the row-level web component. The CSS file may be configured to manage a visual representation of a user interface of the application page (e.g., a user interface of the food application page). The CSS file may also be configured to manage a layout, colors, font, design, size, border, spacing, or any other typographic characteristics associated with the row-level web components on the application page.

The JS file may include JS codes to organize the components of the application page. The JS file may also enable client-side interactions and dynamic logic for the row-level web component on the application page. The JS file may also improve the overall functionality of the row-level web component.

The HTML file may include HTML code corresponding to the row-level web component. The HTML file may define the structure and layout of the row-level web component. The HTML file may be configured to create the content, link, graphics (or pictures) of the row-level web component. The placeholder content file may include sample data, template text, or any other content used during the deployment phase.

The preparing module 204 may retrieve a predefined code corresponding to each of the analytics, the accessibility, and the SEO, based on the predefined schema defined in the schema file. Once the predefined code is retrieved, the preparing module 204 may automatically add the predefined code to the deployment package 500 of the row-level web component. The predefined code may be added to various modules (such as a data collector 504, an accessibility injector 506, structured data 508, etc.) within a platform context layer of the deployment package as explained below.

The predefined code for the analytics may be added to the data collector 504. The data collector 504 may collect the analytics data corresponding to the one or more functional GUI elements of the row-level web component from the application page. Upon collecting the analytics data, the data collector 504 may provide the analytics data to an analytics tool for data analytics and/or data visualization.

The predefined code for the accessibility may be added to the accessibility injector 506. The accessibility injector 506 may collect the accessibility data from the one or more functional GUI elements of the row-level web component. Further, the accessibility injector 506 may create accessibility-related HTML tags based on the accessibility data through the schema file for accessibility.

The predefined code for the SEO may be added to the structured data 508. Further, the structured data 508 may collect the SEO data from the one or more functional GUI elements of the row-level web component. Further, the structured data 508 may create micro-tags and meta-tags for the row-level web components based on the SEO data through the predefined code for SEO. The micro-tags and meta-tags may be used to optimize the application page through better analytics, SEO, and improved accessibility.

Further, the deployment package may include an editorial layer. The editorial layer may connect all the containers (or blocks) of the deployment package 500 (such as, the data collector 504, accessibility injector 506 and structured data 508). The editorial layer 510 may also facilitate editing, content creation, and publishing content corresponding to the row-level web component.

Referring now to FIG. 6, a detailed exemplary process 600 for evaluating the deployment package 500 through one or more automated gates is illustrated, via a flow chart, in accordance with some embodiments of the present disclosure. FIG. 6 is explained in conjunction with FIG. 5. Once the deployment package 500 is prepared, the process 600 may evaluate the deployment package 500 through the one or more automated gates 604. The one or more automated gates 604 may be deployed at a customer beta stage 602 of the application page. The deployment package 500 may be referred to as a prelim package. The deployment package 500 may include a micro frontend and a micro service code.

The customer beta stage 602 is a pre-release type of acceptance test in which target users may evaluate a digital asset (or application page) to determine its overall effectiveness, functionality, reliability, and compatibility. The customer beta stage 602 may review a newly added feature in the application page. By way of an example, the customer reviews the new feature by adding the new feature on the application page which they want to activate or deactivate. At the customer beta stage 602, test features or yet-to-be-added features of the row-level web component may be evaluated before the features get published.

The one or more automated gates 604 may include, but may not be limited to, automation (or performance) tests 604A, an internal X staging 604B, an analytics gate 604C, an SEO gate 604D, a security gate 604E, a Dynamic Application Security Testing (DAST) 604F, a Static Application Security Testing (SAST) 604G, an X Library Repository 604H. In an embodiment, the deployment package 500 may be evaluated in specific series (e.g., step-by-step) through the one or more automated gates 604. In another embodiment, the deployment package 500 may be evaluated parallelly through the one or more automated gates 604.

The automation tests 604A may automate the process of validating the functionality of the one or more functional GUI elements and ensure that the one or more functional GUI elements meet requirements before being released into production. The internal X Staging 604B may be an interstitial test step in the one or more automated gates 604 for evaluation (or checks). The analytics gate 604C may perform quality checks corresponding to the data collector 504 and the predefined code for analytics in the deployment package 500. The SEO gate 604D may perform quality checks corresponding to the structured data 508 and the predefined code for SEO in the deployment package 500. The security gate (e.g., Open web application security project) 604E may perform security checks corresponding to the one or more functional GUI elements in the row-level web component to identify any security risks or vulnerabilities in the one or more functional GUI elements.

The DAST 604F may analyze the row-level web component through front-end to find vulnerabilities through simulated attacks. The DAST 604F may also send an automated alert, if it finds flaws that allow for attacks (such as SQL injection, Cross-Site Scripting (XSS), and the like). It should be noted that the DAST 604F may detect the runtime flaws The SAST 604G may analyse a source code of the row-level web component to find security vulnerabilities that make the users organization's applications susceptible to attack. Further, the SAST 604G may scan the application before the code may compile. The X library repo 604H may also be the interstitial step for the automated test steps 604. The X library repo 604H may store the result of various automated check performed.

Once the one or more automated gates 604 are successfully executed, the deployment package 500 from the customer beta stage 602 may be transmitted to a customer library repository 606. Further, the customer library repository 606 may send the deployment package 500 to a customer live stage 608 of the application page. In other words, the customer library repository 606 may deploy the deployment package 500 (i.e., the row-level web component) on the application page.

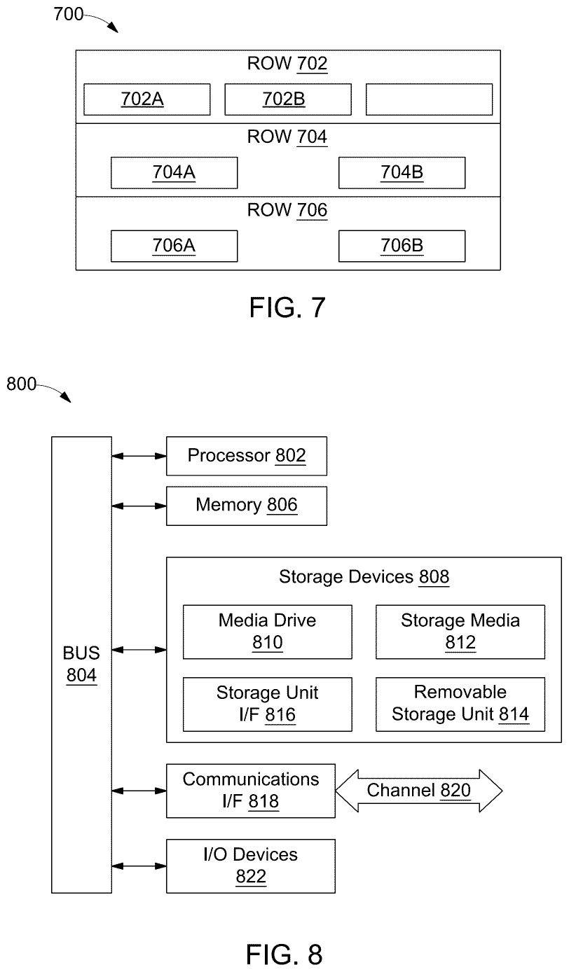

Referring now to FIG. 7, an exemplary Graphical User Interface (GUI) presenting an application page 700 with the deployed row-level web component is illustrated, in accordance with some embodiments of the present disclosure. The GUI 700 may include one or more row-level web components (such as a row 702, a row 704, and a row 706) based on the template selection provided by the user. Once a deployment package (such as the deployment package 500) for each of the one or more row-level web components is successfully evaluated, the deploying module 208 may deploy the one or more row-level web components through the corresponding deployment package on the application page 700. Upon deploying the row-level web component on the application page 700, the rendering module 210 may render, via a GUI, the application page 700 with the deployed row-level web component based on the template selection on the end user device.

By way of an example, the application page 700 (e.g. online shopping page) may include three row-level web components (i.e., the row 702, the row 704, and the row 706). Each of the plurality of row-level web components is configured to span across an entire width of a screen of the end user device. In other words, each of the plurality of row-level web components spans across 100% width of the screen of the end user device. That is to say, the width of a row-level web components depends on the width of the screen of the end user device. It should be noted that each of the row-level web components is restricted from splitting. Thus, a user (i.e., the individual who designs the application page) is not provided a feature to vertically or horizontally split a row-level web component. Each of the plurality of row-level web components is only vertically movable through a user command. By way of an example, the user may only be allowed to move the row 704 vertically upward or downward over the row 702 or the row 706, respectively. When the user moves the row 704 vertically upward to the position of the row 702 on the application page 700, the row 702 may move downwards to the original position of the row 704.

Further, each row-level web component may include one or more slots. By way of an example, the row 702 may include ‘2’ slots (e.g., a slot 702A, and a slot 702B). Similarly, the row 704 may include ‘2’ slots (e.g., a slot 704A, and a slot 704B) and the row 706 may include ‘2’ slots (e.g., a slot 706A, and a slot 706B). In an embodiment, each row may include one or more cards (i.e., the one or more functional GUI elements). Each of the one or more cards is inserted in a slot.

By way of an example, the slot 702A, and the slot 702B of the row 702 may include graphics (e.g., an image related to apparel). The slot 704A and the slot 704B of the row 704 may include ‘content’ associated with the graphics. The content may be, for example, but may not be limited to, price, ratings, brief description, associated with the graphics. The slot 706A and the slot 706B of the row 706 may include reference links associated with the content. Each of the one or more functional GUI elements is arranged at a fixed position in the row-level web component.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

The disclosed methods and systems may be implemented on a conventional or a general-purpose computer system, such as a personal computer (PC) or server computer. Referring now to FIG. 8, an exemplary computing system 800 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 800 may represent, for example, a user device such as a desktop, a laptop, a mobile phone, personal entertainment device, DVR, and so on, or any other type of special or general-purpose computing device as may be desirable or appropriate for a given application or environment. The computing system 800 may include one or more processors, such as a processor 802 that may be implemented using a general or special purpose processing engine such as, for example, a microprocessor, microcontroller or other control logic. In this example, the processor 802 is connected to a bus 804 or other communication medium. In some embodiments, the processor 802 may be an Artificial Intelligence (AI) processor, which may be implemented as a Tensor Processing Unit (TPU), or a graphical processor unit, or a custom programmable solution Field-Programmable Gate Array (FPGA).

The computing system 800 may also include a memory 806 (main memory), for example, Random Access Memory (RAM) or other dynamic memory, for storing information and instructions to be executed by the processor 802. The memory 806 also may be used for storing temporary variables or other intermediate information during execution of instructions to be executed by the processor 802. The computing system 800 may likewise include a read only memory (“ROM”) or other static storage device coupled to bus 804 for storing static information and instructions for the processor 802.

The computing system 800 may also include a storage devices 808, which may include, for example, a media drive 810 and a removable storage interface. The media drive 810 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 812 may include, for example, a hard disk, magnetic tape, flash drive, or other fixed or removable medium that is read by and written to by the media drive 810. As these examples illustrate, the storage media 812 may include a computer-readable storage medium having stored therein particular computer software or data.

In alternative embodiments, the storage devices 808 may include other similar instrumentalities for allowing computer programs or other instructions or data to be loaded into the computing system 800. Such instrumentalities may include, for example, a removable storage unit 814 and a storage unit interface 816, such as a program cartridge and cartridge interface, a removable memory (for example, a flash memory or other removable memory module) and memory slot, and other removable storage units and interfaces that allow software and data to be transferred from the removable storage unit 814 to the computing system 800.

The computing system 800 may also include a communications interface 818. The communications interface 818 may be used to allow software and data to be transferred between the computing system 800 and external devices. Examples of the communications interface 818 may include a network interface (such as an Ethernet or other NIC card), a communications port (such as for example, a USB port, a micro USB port), Near field Communication (NFC), etc. Software and data transferred via the communications interface 818 are in the form of signals which may be electronic, electromagnetic, optical, or other signals capable of being received by the communications interface 818. These signals are provided to the communications interface 818 via a channel 820. The channel 820 may carry signals and may be implemented using a wireless medium, wire or cable, fiber optics, or other communications medium. Some examples of the channel 820 may include a phone line, a cellular phone link, an RF link, a Bluetooth link, a network interface, a local or wide area network, and other communications channels.

The computing system 800 may further include Input/Output (I/O) devices 822. Examples may include, but are not limited to a display, keypad, microphone, audio speakers, vibrating motor, LED lights, etc. The I/O devices 822 may receive input from a user and also display an output of the computation performed by the processor 802. In this document, the terms “computer program product” and “computer-readable medium” may be used generally to refer to media such as, for example, the memory 806, the storage devices 808, the removable storage unit 814, or signal(s) on the channel 820. These and other forms of computer-readable media may be involved in providing one or more sequences of one or more instructions to the processor 802 for execution. Such instructions, generally referred to as “computer program code” (which may be grouped in the form of computer programs or other groupings), when executed, enable the computing system 800 to perform features or functions of embodiments of the present invention.

In an embodiment where the elements are implemented using software, the software may be stored in a computer-readable medium and loaded into the computing system 800 using, for example, the removable storage unit 814, the media drive 810 or the communications interface 818. The control logic (in this example, software instructions or computer program code), when executed by the processor 802, causes the processor 802 to perform the functions of the invention as described herein.

Various embodiments provide method and system for application page creation. The disclosed method and system may receive, via a GUI, a template selection from a plurality of templates for an application page from a user device. Each of the plurality of templates may include a plurality of row-level web components. Each of the plurality of row-level web components may be configured to span across an entire width of a screen of the user device. Each of the plurality of row-level web components may be restricted from splitting. Further, for each row-level web component of the plurality of row-level web components in the template selection, the disclosed method and system may prepare a deployment package for the row-level web component. The deployment package may include the row-level web component and a predefined code for each of accessibility, Search Engine Optimization (SEO), and analytics. Further, for each row-level web component of the plurality of row-level web components in the template selection, the disclosed method and system may evaluate the deployment package through one or more automated gates. Moreover, for each row-level web component of the plurality of row-level web components in the template selection, upon successful evaluation, the disclosed method and system may deploy the row-level web component through the deployment package on the application page. Thereafter, for each row-level web component of the plurality of row-level web components in the template selection, the disclosed method and system may render, via the GUI, the application page with the deployed row-level web component based on the template selection on the user device.

Thus, the disclosed method and system try to overcome the traditional problem of application page creation. The method and system may provide a platform to design an application page without having any software knowledge. The method and system may provide scalability, security, monitoring and observability out of the box for new features. Additionally, the method and system may provide accessibility, Search Engine Optimization (SEO), and analytics for each row-level web component without investing any additional cost. The system and method may use deployment package to enhance the scalability and security of the application page. The method and system may provide an application page in well-arranged (or structured) manner. The method and system may save time, and cost at same level as traditional methods. Moreover, the method and system may require low maintenance and convenient to use.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described a method and system for application page creation. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of application page creation, the method comprising:
receiving, by a processor via a Graphical User Interface (GUI), a template selection from a plurality of templates for an application page from a user device, wherein each of the plurality of templates comprises a plurality of row-level web components, wherein each of the plurality of row-level web components is configured to span across an entire width of a screen of an end user device, and wherein each of the plurality of row-level web components is restricted from splitting; and
for each row-level web component of the plurality of row-level web components in the template selection,
preparing, by the processor, a deployment package for the row-level web component, wherein the deployment package comprises the row-level web component and a predefined schema for each of accessibility, Search Engine Optimization (SEO), and analytics;
evaluating, by the processor, the deployment package through one or more automated gates;
upon successful evaluation, deploying, by the processor, the row-level web component through the deployment package on the application page; and
rendering, by the processor via the GUI, the application page with the deployed row-level web component based on the template selection on the end user device.

2. The method of claim 1, wherein each of the plurality of row-level web components is vertically movable through a user command.

3. The method of claim 1, further comprising generating a new row-level web component through an Artificial Intelligence (AI) model based on the plurality of row-level web components.

4. The method of claim 1, wherein preparing the deployment package for the row-level web component comprises:
retrieving the predefined code for each of the accessibility, the SEO, and the analytics from a database, based on the corresponding predefined schema; and
automatically adding the predefined code to the deployment package of the row-level web component, wherein the row-level web component comprises one or more functional GUI elements.

5. The method of claim 4, further comprising:
collecting analytics data corresponding to each of the one or more functional GUI elements of the row-level web component from the application page through the predefined code for analytics; and
providing the analytics data to an analytics tool through the predefined code for analytics.

6. The method of claim 4, further comprising:
collecting accessibility data from each of the one or more functional GUI elements of the row-level web component through the predefined code for accessibility; and
creating accessibility-related tags based on the accessibility data through the predefined code for accessibility.

7. The method of claim 4, further comprising:
collecting SEO data from each of the one or more functional GUI elements of the row-level web component through the predefined code for SEO; and
creating micro tags and meta tags for the row-level web component based on the SEO data through the predefined code for SEO.

8. The method of claim 4, wherein for each row-level web component of the plurality of row-level web components:
each of the one or more functional GUI elements is arranged at a fixed position in the row-level web component, and
the row-level web component comprises one or more slots corresponding to the one or more functional GUI elements.

9. A system for application page creation, the system comprising:
a processor; and
a memory communicatively coupled to the processor, wherein the memory stores processor instructions, which when executed by the processor, cause the processor to:
receive a template selection from a plurality of templates for an application page from a user device, wherein each of the plurality of templates comprises a plurality of row-level web components, wherein each of the plurality of row-level web components is configured to span across an entire width of a screen of an end user device, and wherein each of the plurality of row-level web components is restricted from splitting; and
for each row-level web component of the plurality of row-level web components in the template selection,
prepare a deployment package for the row-level web component, wherein the deployment package comprises the row-level web component and a predefined schema for each of accessibility, Search Engine Optimization (SEO), and analytics;
evaluate the deployment package through one or more automated gates;
upon successful evaluation, deploy the row-level web component through the deployment package on the application page; and
render, via the GUI, the application page with the deployed row-level web component based on the template selection on the end user device.

10. The system of claim 9, wherein each of the plurality of row-level web components is vertically movable through a user command.

11. The system of claim 9, wherein the processor executable instructions further cause the processor to generate a new row-level web component through an Artificial Intelligence (AI) model based on the plurality of row-level web components.

12. The system of claim 9, wherein to prepare the deployment package for the row-level web component, the processor executable instructions further cause the processor to:
retrieve the predefined code for each of the accessibility, the SEO, and the analytics from a database, based on the corresponding predefined schema; and
automatically add the predefined code to the deployment package of the row-level web component, wherein the row-level web component comprises one or more functional GUI elements.

13. The system of claim 12, wherein the processor executable instructions further cause the processor to:
collect analytics data corresponding to each of the one or more functional GUI elements of the row-level web component form the application page through the predefined code for analytics; and
provide the analytics data to an analytics tool through the predefined code for analytics.

14. The method of claim 12, wherein the processor executable instructions, further cause the processor to:
collect accessibility data from each of the one or more functional GUI elements of the row-level web component through the predefined code for accessibility; and
create accessibility-related tags based on the accessibility data through the predefined code for accessibility.

15. The method of claim 12, wherein the processor executable instructions further cause the processor to:
collect SEO data from each of the one or more functional GUI elements of the row-level web component through the predefined code for SEO; and
create micro tags and meta tags for the row-level web component based on the SEO data through the predefined code for SEO.

16. The system of claim 12, wherein for each row-level web component of the plurality of row-level web components:
each of the one or more functional GUI elements is arranged at a fixed position in the row-level web component, and
the row-level web component comprises one or more slots corresponding to the one or more functional GUI elements.

17. A non-transitory computer-readable medium storing computer-executable instructions for application page creation, the computer-executable instructions configured for:
receiving, via a Graphical User Interface (GUI), a template selection from a plurality of templates for an application page from a user device, wherein each of the plurality of templates comprises a plurality of row-level web components, wherein each of the plurality of row-level web components is configured to span across an entire width of a screen of an end user device, and wherein each of the plurality of row-level web components is restricted from splitting; and
for each row-level web component of the plurality of row-level web components in the template selection,
preparing a deployment package for the each row-level web component, wherein the deployment package comprises the row-level web component and a predefined schema for each of accessibility, Search Engine Optimization (SEO), and analytics;
evaluating the deployment package through one or more automated gates;
upon successful evaluation, deploying the row-level web component through the deployment package on the application page; and
rendering, via the GUI, the application page with the deployed row-level web component based on the template selection on the enduser device.
